(19) United States
(12) Patent Application Publication
(10) Pub. No.: US 2017/0122201 A1
(43) Pub. Date: May 4, 2017

(54) Valve Cover with Integrated Filter Base

(71) Applicant: Caterpillar Inc., Peoria, IL (US)

(72) Inventors: Adrian Porojan, Peoria, IL (US); Derek Grove, Varna, IL (US); Jason Pape, Chillicothe, IL (US)

(73) Assignee: Caterpillar Inc., Peoria, IL (US)

(21) Appl. No.: 14/931,373

(22) Filed: Nov. 3, 2015

(51) Int. Cl. F02B 77/04; F02B 3/08; F02F 7/00; F02B 3/06

(52) U.S. Cl. CPC F02B 77/04; F02B 3/06; F02B 3/08; F02F 7/006; F02B 2077/06

(57) ABSTRACT

A valve cover for an engine and method of filtering is disclosed. The valve cover may include a cover portion and the cover portion includes a top portion, a pair of lateral sides, a pair of end sides and an edge portion. The top portion, the pair of lateral sides and the pair of end sides may have an outer surface and an inner surface. The outer surface on the top portion may define a base support and a filter element may be mounted onto the base support. The valve cover may include an interior space being defined by the inner surface and the edge surface. The edge surface may define a perimeter of the valve cover.

### TECHNICAL FIELD

The present disclosure relates to engines and, more particularly, relates to an engine fluid filter system having a valve cover with an integrated fluid filter base.

### BACKGROUND

Diesel engines are one type of combustion engine that may be used to generate the power needed by, for example, industrial mining equipment, earth-moving equipment, locomotives, on-road trucks, off-road trucks, marine vessels and electricity generating equipment. Engines are composed of many moving parts and during normal operation fluids may flow or circulate throughout the engine to provide lubrication, cooling, protection against corrosion or for other known reasons. However, machinery that use diesel engines may often be operated in harsh environments where extreme temperatures, dust, moisture and other contaminants may act to reduce the operational lifetime of engine fluids. Furthermore, byproducts of the combustion process, such as carbon particles, ash and soot may create additional contamination sources of engine fluids. As a result, in order to extend the lifetime of vital engine fluids some engines may incorporate filtering systems to help remove contaminants and clean the fluids.

Fluid filtering systems may be incorporated with an engine to filter fluids, such as, oil, transmission fluid or fuel. Furthermore, the filtering systems may include replaceable filter elements that are mounted to the engine or attached elsewhere in the machine. As fluid circulates throughout the engine it may be introduced to one or more filtering systems and when the fluid flows through the filter elements some of the particles and contaminants suspended in the fluid may be captured by the filters and removed from the fluid. Furthermore, the filtering element that filters the fluid may be a single use filter that is discarded after a certain amount of use or alternatively, it may be a reusable element that can be cleaned and placed back into service.

As discussed above, oil is one example of an engine fluid that may benefit from some type of in-use filtering. Moreover, one type of oil filtering that can be incorporated with engines may use a by-pass fluid flow system to effectively filter and clean the oil. More specifically, in a by-pass filter system the engine oil, or other fluid to be filtered, typically resides in a reservoir (e.g. oil pan or sump) and is circulated throughout the engine by an oil pump. As the oil circulates it lubricates the engine parts allowing them to slip and slide with relatively little resistance. Moreover, a by-pass oil filter system may use a branched, parallel or split-path oil supply line and a pump to transport the oil from the reservoir to the engine. In such a configuration, the supply line may convey some of the oil from the reservoir to the engine while a branch off the supply line may simultaneously convey some of oil from the reservoir to the filter element. As a result, while the oil continuously circulates throughout the engine, some of the oil may be carried to the engine through the engine oil supply line and some of the oil may be diverted to the oil filter through the oil filter supply line. Furthermore, the oil to be filtered is received by the filter via an inlet port, contaminants are removed from the oil as it flows through the filter element and clean, filtered oil exits the filter element via an outlet port and returns to the oil pan via an oil return line. An alternative type of oil filtering may incorporate a full-flow filtering system. Unlike in a by-pass filter system, a full-flow system may have a single-path oil supply line leading from the reservoir to the engine and a filter element disposed somewhere therebetween. Therefore, all of the oil that is transported through the supply line is directed through the filter element as the oil is pumped from the reservoir to the engine.

An alternative mounting device is described in French Patent FR2603064, (“the '064 patent”). The '064 patent discloses a mounting device for a bypass oil filter element on an internal combustion engine. The invention more particularly relates to a filtering device mounted on an internal combustion engine to provide a filter assembly within the engine. The installation of the type of oil filter disclosed in the '064 patent requires a removable enclosure to ensure the cleaning or replacement of the oil filters can be carried out. Furthermore, the '064 patent mounting device requires the filter element to first be attached to a rocker arm support that is positioned inside a cylinder head cover. The removable cylinder head cover is then placed over the filter element, fully enclosing the filter element. As a result, the '064 patent discloses a filtering element mounting device that fully encloses the filtering element within the cylinder head of an engine.

The addition of an oil filtration system into an engine may provide benefits such as, improved engine efficiency, increased engine oil lifetime, reduction in scheduled maintenance, and reduction of waste oil generation. However, adding these beneficial filtration systems to engines may pose some challenges due to constraints on available space. For example, it may be difficult to add additional filter systems that both fit within the space available in the engine compartment and positioned in a manner that facilitates easy access for routine maintenance. Therefore, efficient use of available space may be required to accommodate all of the engine components and meet the engine packaging requirements. As a result, new designs for engine filtering systems and other components may be needed in order to take full advantage of all available space within the engine compartment.

### SUMMARY OF THE DISCLOSURE

In accordance with one embodiment of the present disclosure, a valve cover for an engine is disclosed. The valve cover may have a cover portion and the cover portion includes a top portion, a pair of lateral sides, a pair of end sides and an edge portion. Furthermore, the top portion, the pair of lateral sides and the pair of end sides may have an outer surface and an inner surface. Additionally, the outer surface on the top portion may define a base support for mounting a filter element and the base support may be elevated from the edge portion. Moreover, the inner surface and the edge portion may define an interior space therebetween and the edge portion forms a perimeter of the valve cover.

In accordance with another embodiment of the present disclosure, an engine is disclosed. The engine may include an engine block, an oil supply line that is in fluid communication with the engine block, an oil reservoir that is in fluid communication with the oil supply line, a pump adapted to facilitate the transport of oil through the oil supply line from the oil reservoir to the engine block and a cylinder head. Furthermore, the engine may have a valve cover configured to cover the cylinder head and the valve cover may form a cover portion, the cover portion may include a top portion, a pair of lateral sides, a pair of end sides and an edge portion. Furthermore, the top portion, the pair of lateral sides and the pair of end sides may have an outer surface and an inner surface. The outer surface on the top portion defines a base support for mounting a filter element, the base support is elevated from the edge portion and the inner surface and the edge portion define an interior space therebetween. Additionally, the edge portion forms a perimeter of the valve cover.

In yet another embodiment of the present disclosure, a method for filtering engine fluid is disclosed. The method of filtering engine oil may include operating an engine having an engine block, a cylinder head formed in the engine block, an oil supply line connecting an oil reservoir to the engine block, a pump for transporting oil from the oil reservoir through the oil supply line to the engine block and an oil return line to transport oil from the engine block to the oil reservoir. The method may further include attaching a valve cover to the cylinder head, the valve cover forms a cover portion, the cover portion includes a top portion, a pair of lateral sides, a pair of end sides and an edge portion. Furthermore, the top portion, the pair of lateral sides and the pair of end sides have an outer surface and an inner surface. Moreover, the method may include defining a base support on the outer surface of the top portion, configuring the base support such that the base support is elevated from the edge portion. The method may further include defining an interior space between the inner surface and the edge portion and the edge portion defining a perimeter of the valve cover. Furthermore, the method may include forming a first opening in the base support, the first opening extending through the outer surface to the inner surface. A filter element may be mounted onto the base support and the filter element may be aligned to overlap with the first opening in the base support. Moreover, the method may include circulating oil through the engine such that the pump conveys oil from the oil reservoir through the oil supply line to the engine block and the filter element. The filter element may clean the oil conveyed therethrough before the oil is transported back to the oil reservoir through the oil return line.

### BRIEF DESCRIPTION OF THE DRAWINGS

FIG. 1 is a perspective view of an exemplary machine incorporating the valve cover with integrated filter base in accordance with the present disclosure;

FIG. 2 is a plan view of an engine incorporating an exemplary embodiment of the valve cover with integrated filter base in accordance with the present disclosure;

FIG. 3 is a perspective view of an embodiment of the valve cover with integrated filter base in accordance with the present disclosure;

FIG. 4 is a perspective view of the interior space an embodiment of the valve cover with integrated filter base of FIG. 3.

FIG. 5 is a schematic illustration of an engine system incorporating another exemplary embodiment of the valve cover with integrated filter base in accordance with the present disclosure.

FIG. 6 is a flow chart depicting a sample sequence of steps which may be practiced in accordance with an exemplary method employing the teachings of the present disclosure.

### DETAILED DESCRIPTION

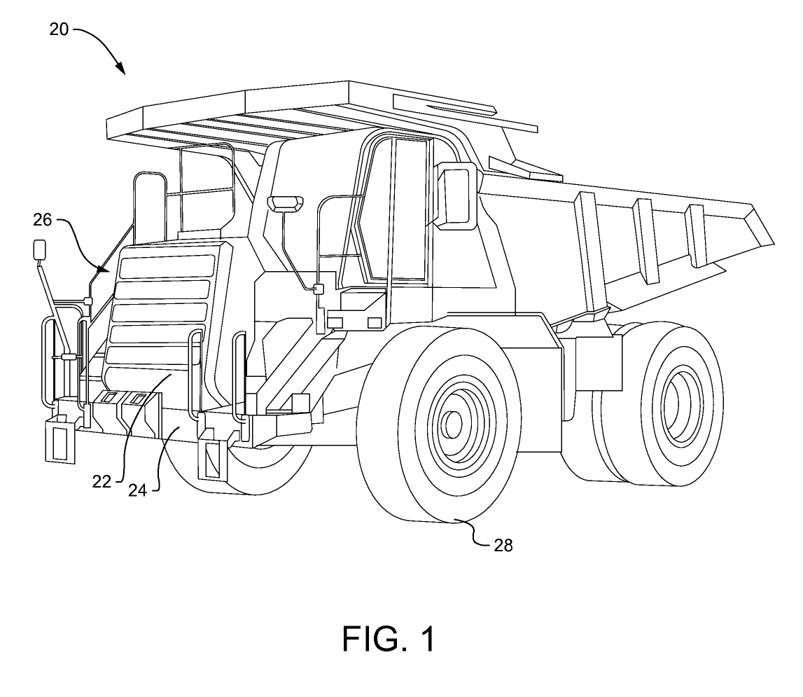

Referring now to the drawings and with specific reference to FIG. 1, an exemplary embodiment of a machine constructed in accordance with the present disclosure is generally referred to by reference numeral 20. While one example is shown, the machine 20 may be any piece of equipment incorporating an engine 22, such as, but not limited to, off-road trucks, on-road trucks, earth moving equipment, industrial mining equipment, locomotives, marine vessels, electricity generating equipment or other known pieces of equipment. Furthermore, the engine 22 may be an internal combustion engine, a diesel engine, a natural gas engine, a hybrid engine or any combination thereof.

The machine 20 may be constructed as having a frame 24 which supports the engine 22. In some embodiments, the engine 22 may be rigidly attached to the frame 24. Furthermore, in some embodiments, the engine 22 may be disposed within an engine compartment 26 and the engine compartment 26 may define a space which contains the engine 22 and other assorted components necessary for operation of the machine 20. Moreover, in exemplary embodiments, the engine 22 and other assorted components may be designed to fit within the available space provided by the engine compartment 26. Furthermore, the machine 20 may utilize a plurality of wheels 28 or other ground engaging elements and the engine 22 may generate the power that is supplied to the wheels 28 for propelling or enabling the machine 20 to do work.

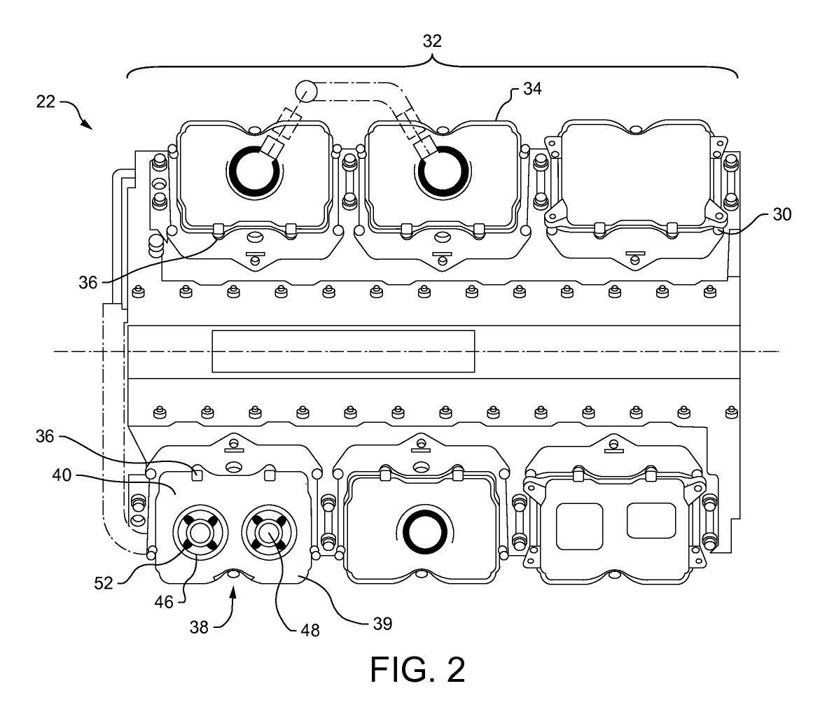

FIG. 2 provides a top view of one embodiment of the engine 22 that may reside in the engine compartment 26 of the machine 20. In one exemplary embodiment, the engine 22 may be a diesel engine but other types of engines are possible. Furthermore, in some embodiments, the engine 22 may include one or more cylinder heads 30 surrounding one or more cylinders (not shown) and pistons (not shown) of the engine 22. The non-limiting embodiment illustrated in FIG. 2, shows the engine 22 is configured to have six cylinder heads 30 and each cylinder head 30 may include two cylinders (not shown), however other configurations of the cylinder heads 30 and cylinders (not shown) having different numbers of cylinder heads 30 and cylinders (not shown) of the engine 22 are possible. Furthermore, in some embodiments, the engine 22 may be configured to be a v-style engine where the cylinder heads 30 are arranged in two separate cylinder head banks 32 and the separate cylinder head banks 32 may be set at an angle with respect to one another. Alternatively, the engine 22 may be configured to be an in-line engine (not shown) where the cylinders (not shown), pistons (not shown) and cylinder heads 30 are arranged in a single row, other configurations of the engine 22 may be possible.

As further illustrated in FIG. 2, the engine 22 may utilize one or more valve covers 34 which are placed on top of the cylinder head 30. Each valve cover may function as a covering or lid for each cylinder head 30. Furthermore, the valve cover 34 and the cylinder head 30 may form an enclosure which houses the cylinders (not shown). In some embodiments, the engine 22 may have multiple valve covers 34 that are attached to the cylinder heads 30. Alternatively, in other embodiments, the engine 22 may have a single valve cover 34 to cover multiple cylinder heads 30. Furthermore, the valve cover 34 may have at least one attachment point 36 for removably attaching the valve cover 34 to the cylinder head 30. In exemplary embodiments, the attachment points 36 may have openings or holes formed in or along the edge portion 44 to facilitate coupling the valve cover 34 with the cylinder head 30. An exemplary attachment of the valve cover 34 to the cylinder head 30 may be accomplished through the use of screws (not shown), pins (not shown), clips (not shown), adhesive (not shown), or other known attachment methods. Moreover, the valve cover 34 may be made from stamped aluminum, stainless steel, resin injection molding or other known compatible materials and manufacturing methods.

As illustrated in FIGS. 2-5, an exemplary embodiment of the present disclosure may include a modification to one or more of the valve covers 34 to create a modified valve cover 38 or a valve cover with an integrated filter base. In one exemplary embodiment, the modified valve cover 38 may form a cover portion 39 and the cover portion 39 has a top portion 41, a pair of lateral sides 43, a pair of end sides 45 and an edge portion 44. Furthermore, the top portion 41, the pair of lateral sides 43 and the pair of end sides 45 may have an outer surface 40, an inner surface 42 and an edge portion 44. Additionally, the outer surface 40 and the inner surface 42 may be separated by a thickness 47 of the material the valve cover is made from and the edge portion 44 may define a perimeter P of the modified valve cover 38. For example, the modified valve cover 38 may be made from stamped aluminum, stainless steel, resin injection molding or other known compatible materials and manufacturing methods.

In some embodiments, the outer surface 40 may have one or more base supports 46. Furthermore, the base support 46 may be configured to have at least one base support opening 48, the base support opening 48 extends through the outer surface 40 to the inner surface 42 of the modified valve cover 38. Moreover, the base support opening 48 may be circular and positioned approximately in the center of the base support 46, however other configurations and locations are possible. Additionally, in some embodiments, the base support 46 may be further configured to support and/or mate with a filter element 50. For example, in some embodiments, the base support 46 may be sloped at a specified angle to provide a level support surface for the filter element 50 when the modified valve cover 38 is attached to the cylinder head 30, however other configurations are possible. In exemplary embodiments, the filter element 50 may be used to remove contaminants that accumulate in engine fluids (not shown) during operation of the engine 22. One non-limiting example of an engine fluid that may be filtered is engine oil, however other fluids such as, but not limited to, transmission fluid, engine coolant, fuel or other known fluids, may be filtered as well.

Moreover, in some embodiments, the filter element 50 may be a centrifugal filter, a cartridge filter, a spin-on filter or other known filter type. The filter element 50 may be disposed on the outer surface 40 of the modified valve cover 38 and removably attached to the base support 46 using one or more filter attachment points 52. The filter element attachment points 52 may have openings formed in the outer surface 40 and in some embodiments, the attachment points 52 may not extend completely through the outer surface 40 to the inner surface 42. Alternatively, the attachment points 52 may have openings extending completely through the outer surface 40 to the inner surface 42 of the modified valve cover 38. Furthermore, the filter attachment points 52 may be threaded or otherwise machined in order to facilitate the attachment of the filter element 50 to the base support 46. In some embodiments the attachment of the filter element 50 to the base support 46 may be accomplished through the use of screws (not shown), pins (not shown) adhesive (not shown) or other known attachment methods. Additionally, the base support opening 48 may be at least partially surrounded by a groove 54 formed in the outer surface 40 of the modified valve cover 38. Alternatively, the base support opening 48 may be completely surrounded by the groove 54. Furthermore, the groove 54 may be circular in shape and have a larger diameter than the base support opening 48, other shapes, sizes and configurations of the groove 54 may be used. In some embodiments, a sealing element (not shown) may be placed in the groove 54 to create a substantially fluid tight seal between the filter element 50 and the base support 46. Some non-limiting examples of the sealing element (not shown) used in combination with the groove 54 may be an o-ring or pressure inverting pedestal (PIP) seal, however other known sealing elements may be used.

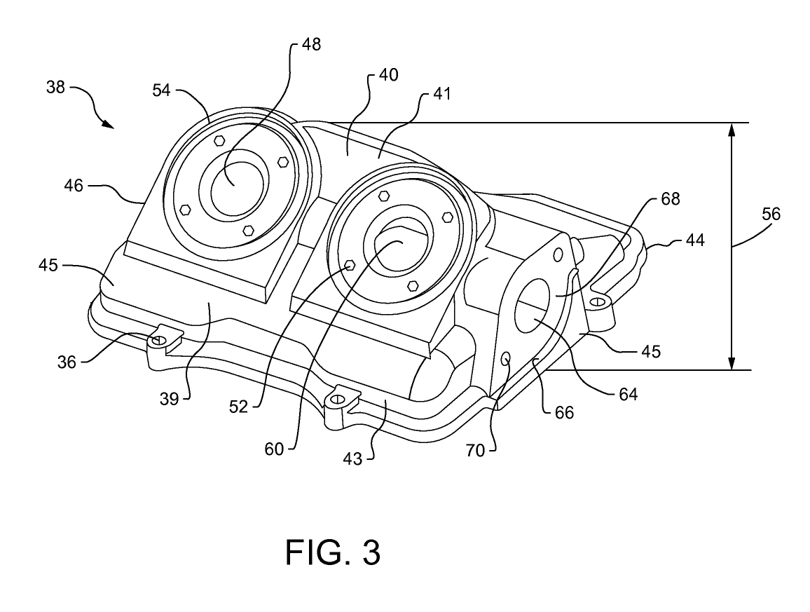

As further illustrated in FIGS. 3-5, the modified valve cover 38 may have a height 56 which forms an interior space 58 of the valve cover 38. In some embodiments the outer surface 40 and inner surface 42 may be contoured and separated by a thickness 47 of the material used to manufacture the modified valve cover 38. For example, the modified valve cover 38 may be made from stamped aluminum, stainless steel, resin injection molding or other known compatible materials and manufacturing methods. Moreover, the outer surface 40 and inner surface 42 may slope towards and merge with the edge portion 44 and the edge portion 44 may form a perimeter P of the modified valve cover 38. Furthermore, the interior space 58 may be, at least partially, defined by the height 56 extending from the edge portion 44. In some embodiments, the base support opening 48 may communicate with the interior space 58 of the modified valve cover 38. Additionally, the interior space 58 may include a channel 60 running along a longitudinal axis of the modified valve cover 38. In some embodiments, the channel 60 may provide an enclosed passageway to transport fluid within the interior space 58 of the modified valve cover 38. Alternatively, the channel 60 may be configured such that it creates an at least partially enclosed passageway to transport fluid within the interior space 58 of the modified valve cover 38.

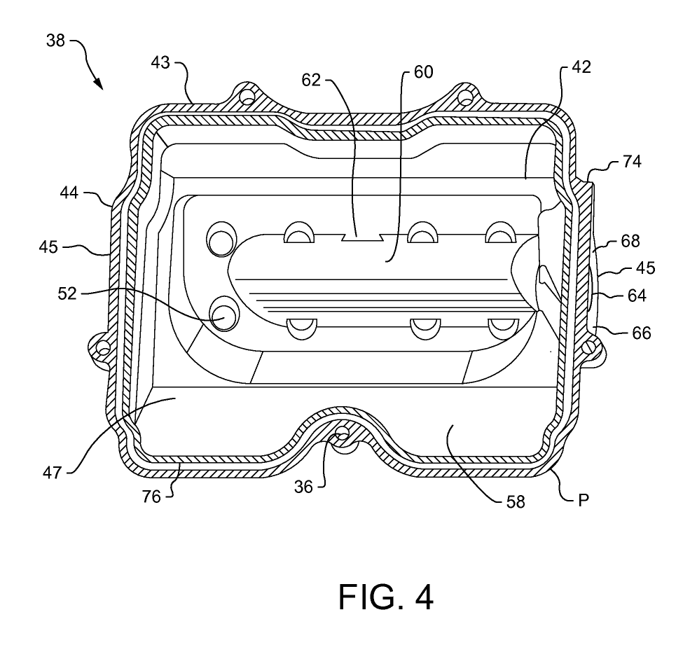

As shown in FIG. 3-4, the base support opening 48 may be aligned with the channel 60 and in some embodiments the base support opening 48 may be in direct communication with the channel 60. In some embodiments, the base support opening 48 may be configured to guide engine fluid (not shown) exiting the filter element 50 to enter the channel 60 within the interior space 58. Furthermore, an overflow drain 62 may be integrated with the channel 60, the overflow drain 62 may be configured as a slit, an aperture or other opening formed in the channel 60. Moreover, the overflow drain 62 may be configured to facilitate proper movement of fluid within the channel 60. In some embodiments, the overflow drain 62 may provide an alternative fluid pathway in the event the fluid level within the channel 60 becomes elevated. During such an event, any excess fluid in the channel 60 may exit through the overflow drain 62 and fall onto the cylinders (not shown) below. Additionally, the overflow drain may ensure proper movement of fluid within the channel 60 by providing an air vent within the channel 60.

In some embodiments, the channel 60 may extend laterally away from the base support opening 48 and terminate at a clean fluid opening 64 formed in the modified valve cover 38. Furthermore, the clean fluid opening 64 may be located along a planar surface 66 that is present on at least one of the end sides 45 of the modified valve cover 38. The clean fluid opening 64 may extend through the inner surface 42 to the outer surface 40 and planar surface 66 may have a groove (not shown) that at least partially surrounds the clean fluid opening 64. Moreover, a sealing element (not shown) may be incorporated within the groove (not shown) that at least partially surrounds the clean fluid opening 64. Furthermore, the clean fluid opening 64 may provide a pathway for the channel 60 to exit the interior space 58 of the modified valve cover 38. In some embodiments, the clean fluid opening 64 may be configured to incorporate a flange 68 along the planar surface 66 of the modified valve cover 38. Additionally, the planar surface 66 and flange 68 may have at least one attachment point 70 configured for removably attaching an external drain tube 72. In some embodiments, the coupling of the external drain tube 72 with the flange 68 along the planar surface 66 may form a substantially fluid tight seal (not shown). Moreover, a sealing element (not shown) may be used with the flange 68 and external drain tube 72 to enhance the substantially fluid tight seal. The sealing element (not shown) may be incorporated within the groove (not shown) that surrounds the clean fluid opening 64. An exemplary attachment of the external fluid drain tube 72 to the flange 68 may be accomplished through the use of screws (not shown), pins (not shown), adhesive (not shown), or other known attachment methods.

As shown in FIGS. 3-4, some embodiments of the modified valve cover 38 may have an edge portion 44. The edge portion 44 may define a perimeter P of the of the modified valve cover 38 and provide a mating surface 74 for coupling the modified valve cover 38 with the cylinder heads 30. Furthermore, in some embodiments the edge portion 44 and mating surface 74 may incorporate a groove 76 and the groove 76 may follow around the perimeter P of the edge portion 44. In some embodiments, a sealing element (not shown) may be incorporated with the groove 76 to create a substantially fluid tight seal between the mating surface 74 and the cylinder head 30. Some non-limiting examples of the sealing element (not shown) used in combination with the groove 76 may be an o-ring or pressure inverting pedestal (PIP) seal, however other known sealing elements may be used. Moreover, some embodiments of the modified valve cover 38 may have one or more attachment points 36 positioned around the perimeter P of the edge portion 44. The attachment points 36 may be holes extending through the edge portion 44 and the holes may contain threads (not shown) or otherwise machined. Furthermore, the attachment points 36 may be tabs (not shown) or any other known structure that may facilitate the removable attachment of the modified valve cover 38 to the cylinder head 30. Moreover, in some embodiments, the attachment of the modified valve cover 38 to the cylinder head 30 may be accomplished through the use of screws (not shown), pins (not shown), clips (not shown), adhesive (not shown), or other known attachment methods.

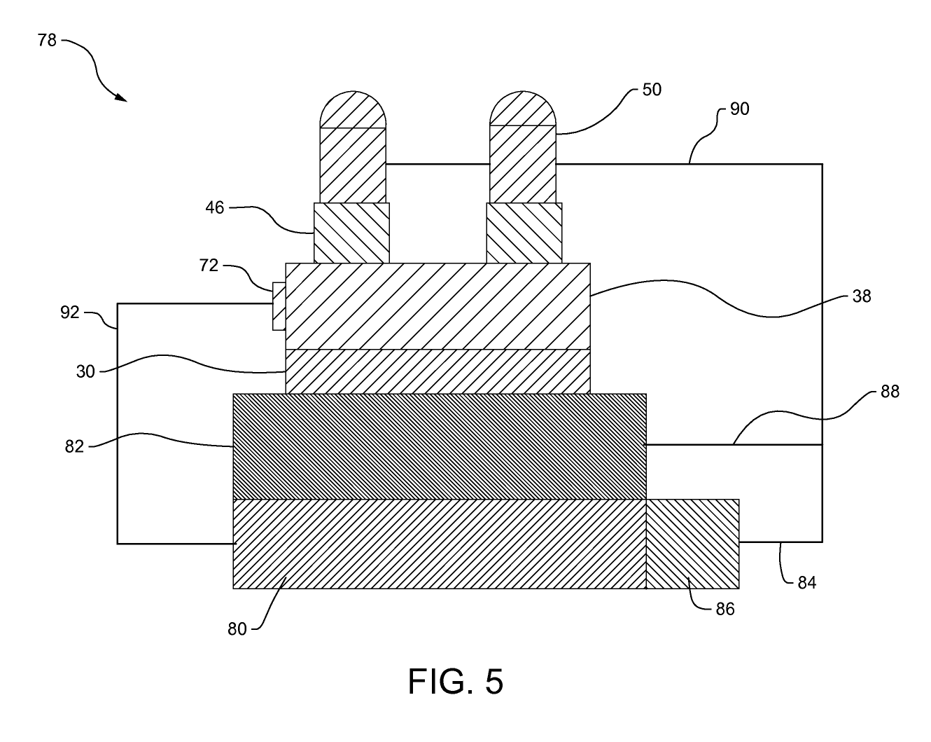

As shown in FIG. 5, an embodiment of an engine system 78 may incorporate the modified valve cover 38 with the engine 22 to introduce or improve the filtration capabilities of engine fluids that may circulate throughout the engine 22. In some embodiments, the engine system 78 may be configured to fit inside an engine compartment 26 of a machine 20. Furthermore, the engine system 78 may include an engine fluid reservoir 80 (e.g. oil pan or sump), an engine block 82, one or more cylinder heads 30 and at least one modified valve cover 38. In some exemplary embodiments, the engine 22 may have one or more valve covers 34 and one or more engine systems 78 incorporating one or more modified valve covers 38. Moreover, at least one filter element 50 may be removably disposed on the modified valve cover 38. In an exemplary embodiment, the filter element 50 is fixed to the base support 46 using attachment points 52 . Furthermore, the engine system 78 may have a fluid supply line 84 to transport engine fluid from the reservoir 80 to the engine block 82. In one non-limiting example, a pump 86 may facilitate the transport of fluid from the reservoir 80 to the engine block 82, but other transport mechanisms may be possible. In some embodiments, the fluid supply line 84 may transport some of the engine fluid from the reservoir 80 to the filter element 50 that is attached to the modified valve cover 38. To accomplish this, some embodiments may be configured having one or more parallel pathways that branch off from the fluid supply line 84 to transport of fluid to different engine 22 locations. In one non-limiting embodiment, the fluid supply line 84 splits or branches into an engine supply line 88 to circulate fluid to the engine block 82 and a filter supply line 90 to circulate fluid to the filter element 50 disposed on the modified valve cover 38. Such a configuration may provide a parallel pathway for fluid to be transported from the reservoir 80 to the engine block 82 and the filter element 50. Furthermore, the engine system 78 may have a fluid return line 92 that transports clean fluid from the modified valve cover 38 back to the reservoir 80. Moreover, the fluid return line 92 may be coupled to the external drain tube 72 to receive the clean fluid from the filter element 50 disposed on the modified valve cover 38.

### INDUSTRIAL APPLICABILITY

In general, the disclosed valve cover with integrated filter base of the present disclosure can find applicability in many industries, including but not limited to, engines used in the earth moving, mining, agricultural and construction industries. Such a valve cover may be configured to be compatible with any type of engine fluid filter. More specifically, the valve cover with integrated filter base may utilize available space within the engine compartment to provide a mounting base for an oil filtering system. One non-limiting example of an oil filtering method using the valve cover with integrated filter base is described below.

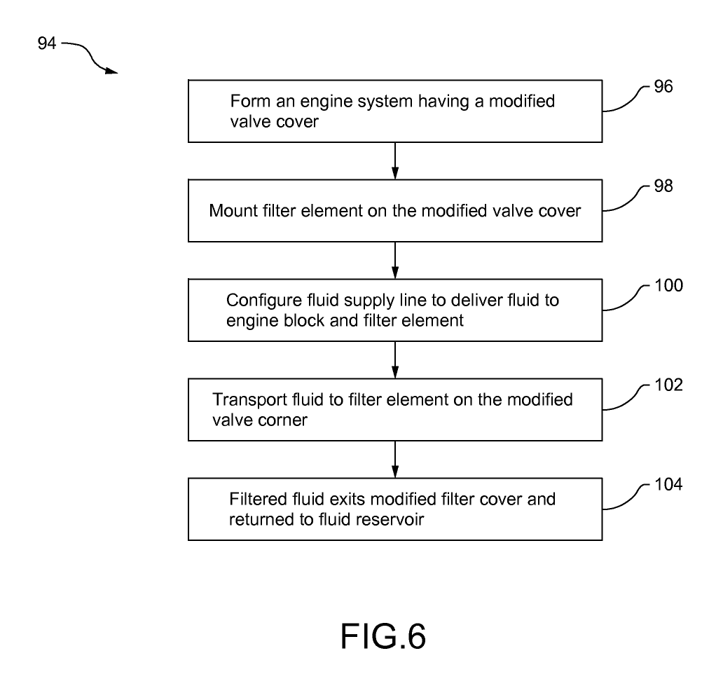

Referring to FIG. 6, an exemplary flowchart is illustrated describing a method 94 which may be followed to filter engine fluid using the modified valve cover 38, as described in the present disclosure. The first step 96 of the method 94 may require operating an engine system 78 having an engine 22 with at least one modified valve cover 38, at least one cylinder head 30, an engine block 82, a fluid supply line 84, a fluid return line 92, a pump 86, and a fluid reservoir 80. In some embodiments, the modified valve cover 38 may have one or more attachment points 36 along the edge portion 44. Furthermore, the one or more attachment points 36 may facilitate coupling the modified valve cover 38 to the cylinder head 30. Moreover, the modified valve cover 38 may serve as a cover or lid to the cylinder head 30.

According to the next step 98 of method 94, a filter element 50 may be removably attached to the base support 46 of the modified valve cover 38. Furthermore, the base support 46 may have an opening 48 extending from the outer surface 40 through the inner surface 42. In some embodiments, the filter element 50 is disposed on the outer surface 40 of the modified valve cover 38. Moreover, the filter element 50 may be positioned to at least partially overlap with the base support opening 48 when the filter element 50 is attached to the base support 46.

In a step 100, the fluid supply line 84 may be configured to deliver fluid to the engine block 82 and the filter element 50. In one non-limiting embodiment, the fluid supply line 84 splits or branches into an engine supply line 88 to convey fluid to the engine block 82 and a filter supply line 90 to convey fluid to the filter element 50. Furthermore, the fluid may be transported from the reservoir 80 to the engine 22 and the filter element 50 by the pump 86.

The next step 102 in method 94 may provide that fluid transported to the modified valve cover 38 is filtered and/or cleaned by the filter element 50. Subsequently, once contaminants and particles are removed by the filter element 50 the fluid may be directed through the base support opening 48 and enter the channel 60 located within the interior space 58 of the modified valve cover 38. Moreover, according to the final step 104, the filtered fluid may continue to move through the channel 60 and exit through the clean fluid opening 64 located along a planar surface 66 of the modified valve cover 38. Furthermore, as the filtered fluid exits through the clean fluid opening 64 it may be funneled into the drain tube 72 that is attached to the flange 68 located on the planar surface 66 of the modified valve cover 38. In some embodiments, the drain tube 72 may be coupled with the fluid return line 92 and the clean fluid may be transported through the fluid return line 92 back to the reservoir 80. Upon return, the clean fluid may mix with the other fluid present the reservoir 80. In an exemplary embodiment of method 94, the fluid will be continuously circulated by the pump 86 and transported either to the engine block 82 to lubricate and or/cool engine components or transported to the filter element 50 to undergo filtration and/or cleaning.

It will be appreciated that the use of a valve cover with integrated filter base provides more efficient use of available space within the engine compartment of machines having a combustion engine or comparable power source. Furthermore, the addition of a by-pass or full-flow engine fluid filtering system may be necessary to adhere with certain regulatory requirements and/or user demands seeking a longer lifetime of certain engine fluids. For example, engine oil is one fluid that may have a shortened lifetime due to the accumulation of contaminants during normal use. As a result, to keep the engine and machine working properly, the fluid needs to be changed according to a certain schedule. More specifically, in machines that use diesel engines environmental conditions, as well as, soot, ash or other by-products from the combustion process may contaminate the oil over time and require the oil to be replaced. However, it is costly and often times difficult to change out the contaminated oil because of the equipment size, remote location of equipment use and loss of productivity due to down time. Furthermore, industrial regulations may push for more efficient equipment operation and a reduction of waste or contaminants produced. As a result, improved filtration of engine fluids is necessary in order to increase the intervals between engine fluid changes, increase engine efficiency and to adhere to certain regulation standards.

The present disclosure achieves the forgoing. More specifically, it will be appreciated that engine fluid filters of the present disclosure are configured to fit within the space provided by the engine compartment. Furthermore, the present disclosure provides easy access to the filter elements needing to be replaced, cleaned or repaired as part of the equipment maintenance schedule.

It will be apparent to those skilled in the art that various modifications and variations can be made to the disclosed valve cover with integrated filter base. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A valve cover for an engine, the valve cover comprising:
a cover portion, the cover portion includes a top portion, a pair of lateral sides, a pair of end sides and an edge portion, the top portion, the pair of lateral sides and the pair of end sides have an outer surface and an inner surface;
the outer surface on the top portion defines a base support for mounting a filter element, the base support is elevated from the edge portion, the inner surface and the edge portion define an interior space therebetween, and the edge portion forms a perimeter of the valve cover.

2. The valve cover of claim 1, wherein the base support has a first opening extending through the outer surface to the inner surface and a groove is defined in the outer surface, the groove at least partially surrounds the first opening.

3. The valve cover of claim 2, wherein the groove incorporates a sealing element to create a fluid tight seal between the filter element and the base support.

4. The valve cover of claim 3, wherein the filter element is a centrifugal oil filter and the base support is adapted with an attachment point for removably attaching the centrifugal oil filter onto the base support of the valve cover.

5. The valve cover of claim 2, wherein the interior space defines a channel, the channel is integrated with the inner surface to form an at least partially enclosed passageway and the channel is formed along an axis within the interior space.

6. The valve cover of claim 5, wherein the first opening in the base support is aligned and in direct communication with the channel formed within the interior space.

7. The valve cover of claim 5, wherein the channel has an overflow drain port, the overflow drain port opening into the interior space of the valve cover.

8. The valve cover of claim 5, wherein one of the end sides has a planar surface, a second opening is formed on the planar surface and the second opening extends through the outer surface to the inner surface and is aligned and in direct communication with the channel.

9. The valve cover of claim 8, wherein the planar surface includes a flange and a groove, the groove at least partially surrounds the second opening in the planar surface and a sealing element incorporated within the groove.

10. The valve cover of claim 1, wherein the edge portion defines a groove along a perimeter thereof and the edge portion includes an attachment point for coupling the valve cover to the engine, a sealing element is incorporated within the groove to create a fluid tight seal between the edge portion and the engine.

11. An engine, comprising:
an engine block;
an oil supply line in fluid communication with the engine block;
an oil reservoir in fluid communication with the oil supply line;
a pump adapted to facilitate the transport of oil through the oil supply line from the oil reservoir to the engine block;
an oil return line in fluid communication with the oil reservoir and configured to transport oil from the engine block to the oil reservoir; and
a cylinder head formed in the engine block, a valve cover configured to cover the cylinder head, the valve cover forms a cover portion, the cover portion includes a top portion, a pair of lateral sides, a pair of end sides and an edge portion, the top portion, the pair of lateral sides and the pair of end sides have an outer surface and an inner surface, the outer surface on the top portion defines a base support for mounting a filter element, the base support is elevated from the edge portion and the inner surface and the edge portion define an interior space therebetween and the edge portion forms a perimeter of the valve cover.

12. The engine of claim 11, wherein the base support has a first opening extending through the outer surface to the inner surface of the valve cover, a groove is defined in the outer surface, the groove at least partially surrounding the first opening and the groove incorporates a sealing element to create a fluid tight seal between the filter element and the base support.

13. The engine of claim 12, wherein the filter element is a centrifugal oil filter and the base support is adapted with an attachment point for removably attaching the centrifugal oil filter onto the base support of the valve cover.

14. The engine of claim 12, wherein the interior space defines a channel, the channel is integrated with the inner surface to form an at least partially enclosed passageway, the channel is formed along an axis within the interior space, the first opening in the base support is aligned and in direct communication with the channel and the channel has an overflow drain port opening into the interior space.

15. The engine of claim 14, wherein one of the end sides includes a planar surface, a second opening is formed on the planar surface and extends through the outer surface to the inner surface, the second opening is aligned and in direct communication with the channel, the planar surface includes a flange and a groove, the groove at least partially surrounds the second opening, a sealing element is incorporated within the groove, wherein the flange, the groove and the sealing element are configured to create a fluid tight seal between an external drain tube and the planar surface.

16. The engine of claim 15, wherein the oil return line is coupled to the external drain tube and the oil return line distributes clean oil from the valve cover back to the oil reservoir.

17. The engine of claim 11, wherein the valve cover is made from stamped aluminum, the edge portion defines a groove along a perimeter thereof, the edge portion includes an attachment point configured to couple the valve cover to the cylinder head and the edge portion has a sealing element incorporated within the groove to create a fluid tight seal between the edge portion and the cylinder head.

18. The engine of claim 11, wherein the oil supply line has a first branch and a second branch, the first branch is formed in a parallel configuration with the second branch, and the pump distributes oil simultaneously from the oil reservoir to the engine block through the first branch and from the oil reservoir to the filter element through the second branch.

19. A method for filtering engine oil, the method comprising:
operating an engine having an engine block, a cylinder head formed in the engine block, an oil supply line connecting an oil reservoir to the engine block, a pump for transporting oil from the oil reservoir through the oil supply line to the engine block and an oil return line to transport oil from the engine block to the oil reservoir;
attaching a valve cover to the cylinder head, the valve cover forms a cover portion, the cover portion includes a top portion, a pair of lateral sides, a pair of end sides and an edge portion, the top portion, the pair of lateral sides and the pair of end sides have an outer surface and an inner surface, the outer surface defines a base support on the top portion, the base support is elevated from the edge portion, the inner surface and the edge portion define an interior space therebetween and the edge portion forms a perimeter of the valve cover;
forming a first opening in the base support, the first opening extending through the outer surface to the inner surface, mounting a filter element onto the base support and aligning the filter element to overlap with the first opening in the base support; and
circulating oil through the engine such that the pump conveys oil from the oil reservoir through the oil supply line, to the engine block and the filter element, the filter element cleaning the oil conveyed therethrough before being transported back to the oil reservoir through the oil return line.

20. The method of claim 19, further comprising:
defining a groove at least partially surrounding the first opening in the base support and the groove incorporates a sealing element to create a fluid tight seal between the filter element and the base support;
adapting the base support with an attachment point for removably attaching the filter element onto the base support;
defining a channel within the interior space of the valve cover, the channel is integrated with the inner surface to form an at least partially enclosed passageway;
aligning the first opening of the base support to be in direct communication with the channel and the channel is formed along an axis within the interior space;
forming a second opening through a planar surface on one of the end sides of the valve cover, the second opening extends through the outer surface to the inner surface and the second opening is aligned and in direct communication with the channel;
forming a flange and a groove on the planar surface on one of the end sides, the groove at least partially surrounds the second opening on the planar surface;
inserting a sealing element within the groove;
attaching an external drain tube to the flange such that the flange and sealing element create a fluid tight seal between the external drain tube and the second opening; and
connecting the external drain tube to the oil return line.
